(19) United States
(12) Patent Application Publication
(10) Pub. No.: US 2025/0381778 A1
(43) Pub. Date: Dec. 18, 2025

(54) Liquid Ejection Device

(71) Applicant: SEIKO EPSON CORPORATION, Tokyo (JP)

(72) Inventors: Chikara KOJIMA, Matsumoto (JP); Eiji OSAWA, Matsumoto (JP); Shingo TOMIMATSU, Shiojiri (JP)

(21) Appl. No.: 19/234,758

(22) Filed: Jun. 11, 2025

(30) Foreign Application Priority Data
Jun. 12, 2024 (JP) 2024-095007

(51) Int. Cl. B41J 2/14; B41J 2/045; B41J 2/175

(52) U.S. Cl. CPC B41J 2/14; B41J 2/04588; B41J 2/17503

(57) ABSTRACT

A liquid ejection device includes an ejection head including a nozzle plate having a first surface in which a plurality of nozzles are provided and a liquid supply path configured to supply liquid to the plurality of nozzles; a storage case facing the first surface of the nozzle plate; and an ultrasonic generator that is provided in the storage case and that is configured to generate ultrasonic waves, wherein the ultrasonic generator is configured to, by the ultrasonic waves propagated to the nozzle plate through the storage case, generate standing waves inside the plurality of nozzles.

The present application is based on, and claims priority from JP Application Serial Number 2024-095007, filed Jun. 12, 2024, the disclosure of which is hereby incorporated by reference herein in its entirety.

### BACKGROUND

### 1. Technical Field

The present disclosure relates to a liquid ejection device.

### 2. Related Art

In the related art, a liquid ejection device for ejecting liquid has been known (for example, JP-A-2003-145782). The liquid ejection device described in JP-A-2003-145782 is an inkjet printer and ejects ink as a liquid from nozzles. In the liquid ejection device of JP-A-2003-145782, the nozzle is provided with a heating element, a pressure detection element, and an ultrasonic wave vibrator. Then, clogging of the nozzles is detected using the pressure detection element and the nozzles are cleaned by supplying cleaning liquid to the nozzles, heating the cleaning liquid with the heating element, and applying ultrasonic wave vibration from the ultrasonic wave vibrator.

However, in the liquid ejection device of JP-A-2003-145782, it is necessary to disposed the ultrasonic wave vibrator, the heating element, and the pressure detection element for each nozzle. Therefore, there is a problem in that the configuration of the nozzles and the liquid ejection head on which the nozzles are mounted becomes complicated and the liquid ejection head becomes large.

### SUMMARY

A liquid ejection device according to one aspect of the present disclosure, the liquid ejection device includes an ejection head including a nozzle plate having a first surface in which a plurality of nozzles are provided and in which openings through which liquid is ejected from the nozzles is provided and a liquid supply path configured to supply liquid to the nozzle; a storage case facing the first surface of the nozzle plate; and an ultrasonic generator that is provided in the storage case and that is configured to generate ultrasonic waves, wherein the ultrasonic generator is configured to, by the ultrasonic waves propagated to the nozzle plate through the storage case, generate standing waves inside the plurality of nozzles.

### BRIEF DESCRIPTION OF THE DRAWINGS

FIG. 1 is a schematic view showing an overall configuration of a liquid ejection device according to a first embodiment.

FIG. 2 is a block diagram showing a schematic configuration of a printer according to the first embodiment.

FIG. 3 is a schematic cross-sectional view showing an ejection mechanism in an ejection head according to the first embodiment.

FIG. 4 is a view showing a schematic configuration of a part of the ejection head and a storage case in a state where the ejection head is stored in the storage case in the first embodiment.

FIG. 5 is a view showing an example of standing waves formed in a nozzle in the first embodiment.

FIG. 6 is a view showing the relationship between the frequency of ultrasonic waves and sound pressure at an opening section (+Z side end section) of the nozzle.

FIG. 7 is a flow chart showing a cleaning method in the printer of the first embodiment.

FIG. 8 is a view showing a schematic configuration of a part of the ejection head and the storage case in a state where the ejection head is stored in the storage case in the second embodiment.

### DESCRIPTION OF EMBODIMENTS

### First Embodiment

Hereinafter, a liquid ejection device according to a first embodiment of the present disclosure will be described.

### Schematic Configuration of Printer 10

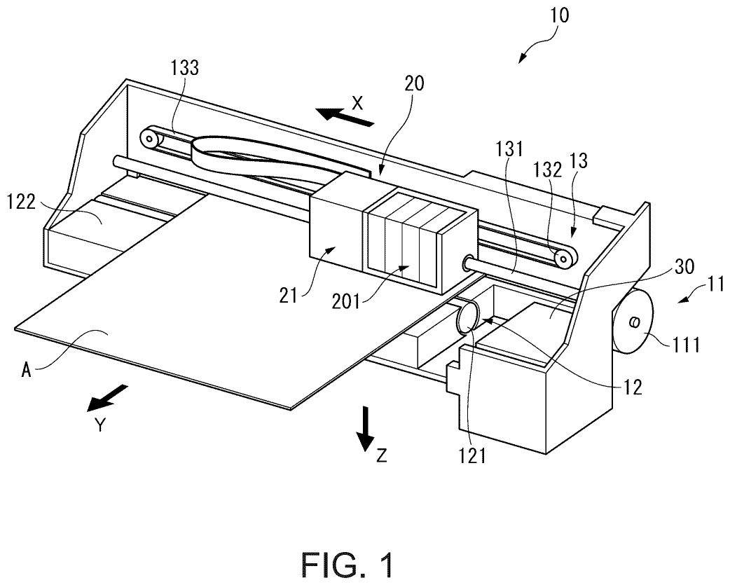

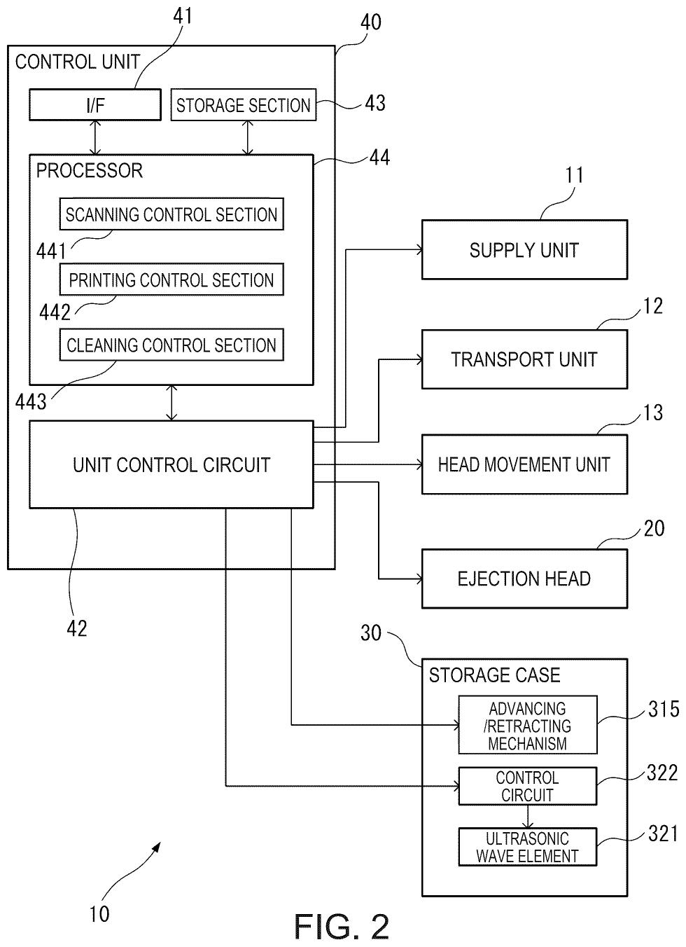

FIG. 1 is a view showing a configuration example of the appearance of a printer 10 according to the present embodiment. FIG. 2 is a block diagram showing a schematic configuration of the printer 10 according to the present embodiment.

The printer 10 of the present embodiment is an example of a liquid ejection device of the present disclosure and is a device that ejects ink containing a coloring material as a liquid onto a medium A to form an image.

As shown in FIG. 1, the printer 10 includes a supply unit 11, a transport unit 12, an ejection head 20, a head movement unit 13, a storage case 30, and a control unit 40 (see FIG. 2). This printer 10 controls the units 11, 12, 13, and the ejection head 20 based on print data input from an external device (not shown) such as, for example, a personal computer, and prints an image on the medium A.

Hereinafter, each configuration of the printer 10 will be described in detail.

The supply unit 11 is a unit that supplies the medium A, on which an image is to be formed, to an image forming position. The supply unit 11 includes, for example, a roll body 111 around which the medium A is wound, a roll drive motor (not shown), and a roll drive gear train (not shown). Based on a command from the control unit 40, the roll drive motor is rotationally driven, and the rotational force of the roll drive motor is transmitted to the roll body 111 via the roll drive gear train. By this, the roll body 111 rotates, and the medium A wound on the roll body 111 is supplied to a +Y side.

Note that, in the present embodiment, an example of supplying a paper wound around the roll body 111 is shown, but not limited to this. For example, the medium A, such as paper sheets stacked on a tray or the like, may be supplied one by one by a roller or the like, or any other supplying method may be used to supply the medium A.

As the medium A of the present embodiment, in addition to paper such as printing paper, film, cloth, or the like can also be used.

The transport unit 12 sends out the medium A supplied from the supply unit 11 to the +Y side. The transport unit 12 includes a transport roller 121, a driven roller (not shown) that is disposed at a position sandwiching the medium A with respect to the transport roller 121 and that follows the transport roller 121, and a platen 122.

The transport roller 121 receives a driving force from a transport motor (not shown), and when the transport motor is driven under the control of the control unit 40, the transport roller 121 is rotationally driven by the rotational force to transport the medium A along a Y direction in a state in which the medium A is sandwiched between the transport roller 121 and the driven roller. The platen 122, which is opposed to the ejection head 20, is provided on the +Y side of the transport roller 121.

The head movement unit 13 reciprocates the ejection head 20 along an X direction based on a command from the control unit 40.

The head movement unit 13 includes, for example, a carriage guide shaft 131, a carriage motor 132, and a timing belt 133.

The carriage guide shaft 131 is disposed along the X direction, and both end sections are fixed to a housing of the printer 10. The carriage motor 132 drives the timing belt 133. The timing belt 133 is supported substantially parallel to the carriage guide shaft 131, and a part of the ejection head 20 is fixed. When the carriage motor 132 is driven based on a command from the control unit 40, the timing belt 133 runs forward and backward, and the ejection head 20, which is fixed to the timing belt 133, reciprocates while being guided by the carriage guide shaft 131.

### Configuration of Ejection Head 20

The ejection head 20 includes an ejection mechanism 21 and liquid containers 201. The liquid containers 201 are, for example, ink cartridges that are attachably and detachably provided on the ejection head 20 and store ink to be supplied to the ejection mechanism 21. In the present embodiment, the liquid containers 201 are exemplified by ink cartridges, but may be bag-shaped ink packs formed of a flexible film, ink tanks that can be refilled with ink, or the like.

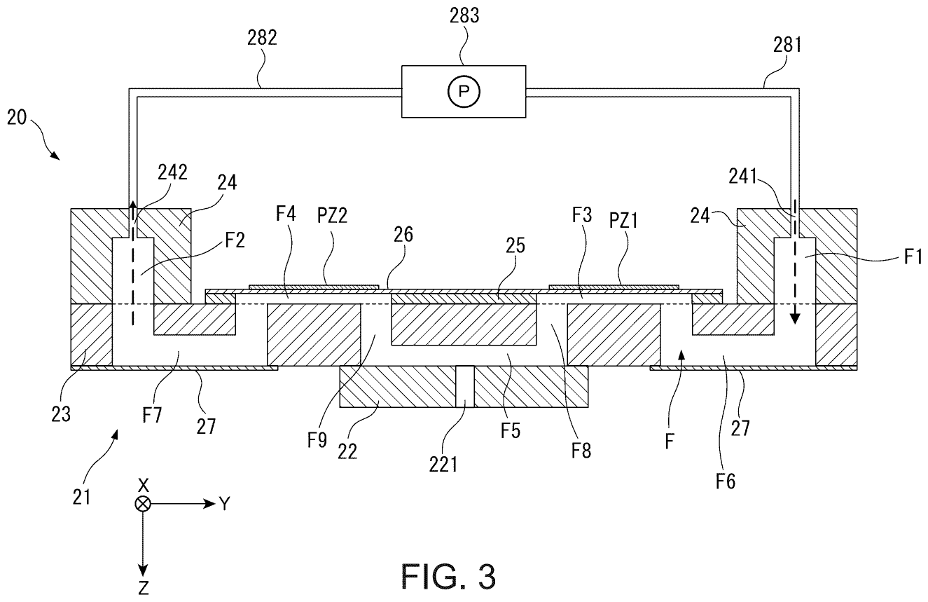

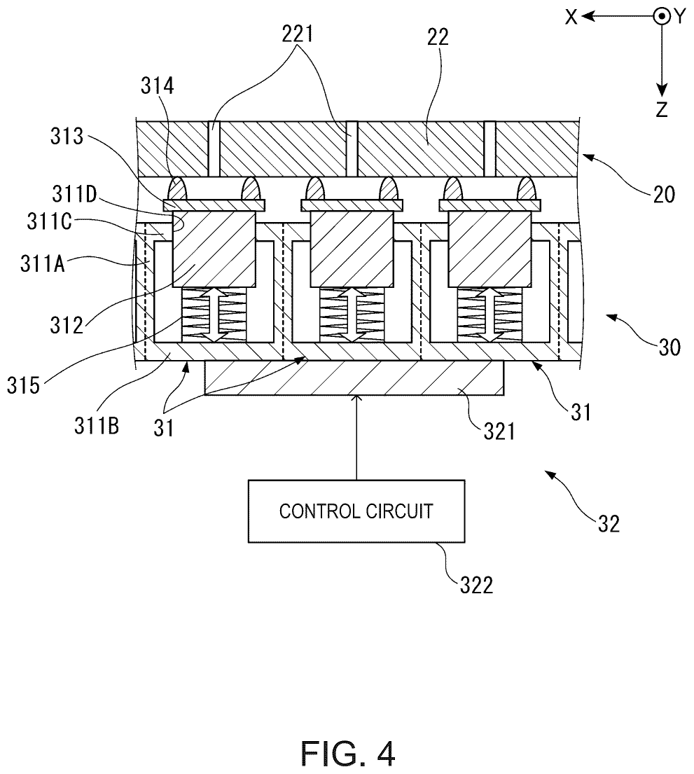

FIG. 3 is a schematic cross-sectional view showing the ejection mechanism 21 in the ejection head 20. FIG. 4 is a view showing a schematic configuration of a part of the ejection head 20 and the storage case 30 in a state where the ejection head 20 is stored in the storage case 30 in the present embodiment. The direction of dashed arrow in FIG. 3 indicates a direction in which the ink, which is liquid, flows. The ejection head 20 has a plurality of ejection mechanisms 21 disposed in the X direction as shown in FIG. 3.

The ejection mechanism 21 includes a nozzle plate 22, a communication plate 23, a common liquid chamber forming board 24, a pressure chamber board 25, a pressure applying plate 26, and a sealing sheet 27.

Here, in the present embodiment, in the ejection head 20, a liquid ejection direction is set as a Z direction, a direction orthogonal to the Z direction is set as the X direction, and a direction orthogonal to the X direction and the Z direction is set as the Y direction. In the present embodiment, the plurality of ejection mechanisms 21 shown in FIG. 3 are disposed in the X direction as shown in FIG. 4.

The nozzle plate 22 is a plate-shaped member that is disposed so as to be substantially parallel to an XY plane when medium A is transported to a printing position. The nozzle plate 22 has nozzles 221 formed therein that function as ejection ports for ejecting the ink, which is liquid. The nozzle 221 is a through hole provided in the nozzle plate 22. The nozzle 221 may be formed in an inner circumferential cylindrical shape parallel to an ink ejection direction, or it may be formed so that the opening diameter narrows along the ink ejection direction.

The surface on the +Z side of the nozzle plate 22 is the first surface of the present disclosure and faces the storage case 30 when the ejection head 20 moves to a home position. The surface on the −Z side of the nozzle plate 22 is the second surface of the present disclosure, and a liquid supply path through which the ink flows is configured by providing the communication plate 23, the common liquid chamber forming board 24, the pressure chamber board 25, the pressure applying plate 26, and the sealing sheet 27.

The nozzle plate 22 is common to the plurality of ejection mechanisms 21, and as shown in FIG. 4, the nozzle plate 22 is provided with the plurality of nozzles 221 disposed in the X direction.

The communication plate 23 is provided on the −Z side surface of the nozzle plate 22. The communication plate 23 is a plate-like member disposed to be substantially parallel to the XY plane. The communication plate 23 is provided with a plurality of through holes and forms a part of an in-head flow path F (to be described later).

The common liquid chamber forming board 24 is provided on the −Z side surface of the communication plate 23. A first common liquid chamber F1 and a second common liquid chamber F2 are formed by a region surrounded by the common liquid chamber forming board 24 and the communication plate 23. A first through hole 241 penetrating the common liquid chamber forming board 24 is formed on the −Z side of the first common liquid chamber F1. The first common liquid chamber F1 is connected to a first flow path 281 through the first through hole 241. A second through hole 242 is formed on the −Z side of the second common liquid chamber F2. The second common liquid chamber F2 is connected to a second flow path 282 through the second through hole 242.

The pressure chamber board 25 is a plate-shaped member provided on the −Z side surface of the communication plate 23. The pressure chamber board 25 is disposed so as to be substantially parallel to the XY plane.

The pressure applying plate 26 is a plate-shaped member provided on the −Z side surface of the pressure chamber board 25. The pressure applying plate 26 is also a member that can be elastically vibrated. The pressure chambers F3 and F4 are formed by the communication plate 23, the pressure chamber board 25, and the pressure applying plate 26. The pressure chambers F3 and F4 are spaces extending in a Y-axis direction. The pressure applying plate 26 is disposed so as to be substantially parallel to the XY plane. On the −Z side surface of the pressure applying plate 26, head-side piezoelectric elements PZ1 and PZ2 corresponding to the pressure chambers F3 and F4, respectively, are provided. The head-side piezoelectric elements PZ1 and PZ2 are energy conversion elements that convert electric energy transmitted from the control unit 40 into kinetic energy. The pressure applying plate 26 bends due to the displacement of the head-side piezoelectric elements PZ1 and PZ2, thereby applying pressure to the ink in the pressure chambers F3 and F4. The applied pressure causes the ink to be ejected from the nozzle 221.

The sealing sheet 27 is provided on the +Z side surface of the communication plate 23. For the sealing sheet 27, for example, an elastic material is used. The sealing sheet 27 absorbs pressure fluctuation of the ink in the in-head flow path F (to be described later).

Within the ejection mechanism 21 of the ejection head 20, an in-head flow path F is formed by the above described communication plate 23, the pressure chamber board 25, the pressure applying plate 26, the common liquid chamber forming board 24, and the sealing sheet 27. The in-head flow path F is a flow path in the ejection head 20 until the ink supplied from the first flow path 281 is discharged to the second flow path 282. One end of the in-head flow path Fis connected to the first flow path 281, and the other end thereof is connected to the second flow path 282. Specifically, the in-head flow path F includes the first common liquid chamber F1, the second common liquid chamber F2, the pressure chambers F3 and F4, a nozzle flow path F5, a first connection flow path F6, a second connection flow path F7, a third connection flow path F8, and a fourth connection flow path F9. The first connection flow path F6 is a flow path connecting the first common liquid chamber F1 and the pressure chamber F3. The second connection flow path F7 connects the pressure chamber F4 and the second common liquid chamber F2. The third connection flow path F8 connects the pressure chamber F3 and the nozzle flow path F5. The fourth connection flow path F9 connects the nozzle flow path F5 and the pressure chamber F4. The nozzle flow path F5 is a flow path extending in the Y-axis direction and is connected to the nozzle 221 in the vicinity of the center in the Y-axis direction.

In the present embodiment, a pump 283 supplies the ink stored in the liquid container 201 from the first flow path 281 to the first common liquid chamber F1. The pump 283 returns the ink flowing out from the second common liquid chamber F2 to the second flow path 282 to the first flow path 281 for circulation.

The pump 283 can select one of a plurality of types of the ink stored in the liquid container and supply it to one ejection head 20 under the control of the control unit 40. That is, by the control unit 40 switching the type of liquid, a plurality of types of liquid can be individually supplied to the ejection head 20 of the present embodiment.

Note that the first flow path 281, the second flow path 282, the pump 283, and the liquid container may be provided in the ejection head 20. Alternatively, the liquid container and the pump 283 may be separate from the ejection head 20, and the first flow path 281 and the second flow path 282 may be connected to the ejection head 20.

### Configuration of Storage Case 30

The storage case 30 is a member that faces the nozzle plate 22 of the ejection head 20 when the ejection head 20 is moved by the head movement unit 13 to the home position at the −X side end section.

As shown in FIG. 4, the storage case 30 includes a plurality of caps 31 facing the nozzle plate 22. Each cap 31 is provided to face each nozzle 221 of the nozzle plate 22. The cap 31 includes a guide section 311, an advancing/retracting section 312 held by the guide section 311 so as to be able to advance and retract, a lid section 313 disposed on the −Z side of the advancing/retracting section 312, a sealing section 314 disposed on the −Z side of the lid section 313, and an advancing/retracting mechanism 315 for advancing and retracting the advancing/retracting section 312 in the Z direction.

The guide section 311 includes, for example, a sidewall section 311A extending in the Z direction and guiding the advancing and retracting movement of the advancing/retracting section 312, a bottom surface section 311B provided on the +Z side of the sidewall section 311A, and a top surface section 311C provided on the −Z side of the sidewall section 311A. The top surface section 311C faces the nozzle plate 22 when the ejection head 20 is moved to the home position. An opening section 311D is provided in the top surface section 311C, and the advancing/retracting section 312 advances and retracts into and out of the guide section 311 through the opening section 311D. The advancing/retracting mechanism 315 is provided between the advancing/retracting section 312, which is inserted into the guide section 311, and the bottom surface section 311B.

The advancing/retracting section 312 is a member for holding the lid section 313 and the sealing section 314, and advances and retracts in the Z direction by the advancing/retracting mechanism 315.

The lid section 313 is a plate-shaped member that faces the nozzle 221 on the −Z side of the advancing/retracting section 312 and is formed in a flat plate shape parallel to the XY plane.

The sealing section 314 is an annular member provided on the −Z side of the lid section 313. When the ejection head 20 is moved to the home position and the advancing/retracting section 312 is moved to the −Z side, the sealing section 314 contacts against the nozzle plate 22 in a state where the nozzle 221 is positioned on the annular inner periphery side of the sealing section 314. By this, as shown in FIG. 4, the nozzle 221 is sealed by being surrounded by the lid section 313 and the sealing section 314. It is desirable that the sealing section 314, for example, is constituted by an elastic body such as silicone rubber and, when the advancing/retracting section 312 moves to the −Z side and the sealing section 314, is pressed against the nozzle plate 22 and, by being elastically deformed, contacts the nozzle plate 22 without a gap.

The advancing/retracting mechanism 315 is a mechanism for advancing and retracting the advancing/retracting section 312 in the Z direction. The specific configuration of the advancing/retracting mechanism 315 is not particularly limited. As the advancing/retracting mechanism 315, for example, a configuration can be exemplified in which an engaging section that restricts the movement of the advancing/retracting section 312 and a biasing member such as a spring are provided, and when the ejection head 20 moves to the home position, the restriction of the movement by the engaging section is released and the advancing/retracting section 312 moves to the −Z side by the biasing member. Alternatively, the advancing/retracting mechanism 315 may be constituted by a motor or an actuator for moving the advancing/retracting section 312 in the Z direction by application of a voltage.

The storage case 30 is provided with an ultrasonic generator 32. The ultrasonic generator 32 includes an ultrasonic wave element 321 and a control circuit 322.

The ultrasonic wave element 321 is provided on a part of the cap 31, for example, on an outer peripheral surface of the +Z side. As the ultrasonic wave element 321, for example, a bulk-type piezoelectric element can be used, and such a bulk-type piezoelectric element propagates ultrasonic waves to the cap 31 of the storage case 30 by vibrating due to the application of a drive voltage, and the ultrasonic waves are propagated from the cap 31 to the nozzle plate 22.

The control circuit 322 is a controller of the present disclosure and generates the drive voltage to be output to the ultrasonic wave element 321 to drive the ultrasonic wave element 321. The control circuit 322 can change the frequency of the drive voltage within a predetermined band, whereby the frequency of the ultrasonic waves output from the ultrasonic wave element 321 can also be changed within a predetermined frequency range.

The ultrasonic waves generated by the ultrasonic wave element 321 are transmitted to the nozzle plate 22 of the ejection head 20 and the ink in the in-head flow path F via the guide section 311, the advancing/retracting section 312, the lid section 313, and the sealing section 314 of the cap 31. These ultrasonic waves form standing waves in the nozzle 221, and it is possible to suppress the adhesion of foreign matter to the nozzle 221 and to remove adhered foreign matter.

### Configuration of Control Unit 40

As shown in FIG. 2, the control unit 40 is configured to include an I/F 41, a unit control circuit 42, a storage section 43, and a processor 44.

The I/F 41 inputs print data from an external device to the processor 44.

The unit control circuit 42 is provided with a control circuit for controlling the supply unit 11, the transport unit 12, the head movement unit 13, the ejection head 20, and the storage case 30, and controls the operation of each unit based on command signals from the processor 44. A control circuit for each unit may be provided separately from the control unit 40 and connected to the control unit 40.

The storage section 43 is, for example, an information storage device such as a semiconductor memory or a hard disk, and stores various programs and various data for controlling the operation of the printer 10.

The processor 44 reads out and executes various programs stored in the storage section 43, thereby functioning as a scanning controller 441, a printing controller 442, a cleaning controller 443, and the like.

The scanning controller 441 outputs the command signals for driving the supply unit 11, the transport unit 12, and the head movement unit 13 to the unit control circuit 42. By this, the unit control circuit 42 drives the roll drive motor of the supply unit 11 to supply medium A to the transport unit 12. The unit control circuit 42 drives the transport motor of the transport unit 12 to transport a predetermined region of the medium A in the Y direction to a position opposite the ejection head 20 of the platen 122. The unit control circuit 42 drives the carriage motor 132 of the head movement unit 13 to move the ejection head 20 along the X direction.

The printing controller 442 controls printing by the ejection head 20 based on print data input from, for example, an external device. When the command signal is output from the printing controller 442 to the unit control circuit 42, the unit control circuit 42 outputs a print control signal including the position of the ejection mechanism 21 that causes the ejection head 20 to eject the ink. By this, the ejection head 20 drives the head-side piezoelectric elements PZ1 and PZ2 of the corresponding ejection mechanism 21 to eject the ink onto the medium A. Note that when printing is performed, the ejection head 20 is moved along the X direction, a dot forming operation of forming dots by ejecting the ink from the nozzle 221 during the movement and a transport operation of transporting the medium A in the Y direction are alternately repeated, and an image composed of a plurality of dots is printed on the medium A.

The cleaning controller 443 performs a cleaning process of the ejection head 20. For example, in the printer 10 of the present embodiment, in a case where printing control is not performed, the ejection head 20 is moved to the home position. When the ejection head 20 is moved to the home position, the cleaning controller 443 moves the advancing/retracting section 312 of the storage case 30 to the −Z side to bring the sealing section 314 into contact with the nozzle plate 22, thereby sealing the nozzle 221. Then, the cleaning controller 443 outputs a command to the ultrasonic generator 32 to operate at a preset frequency. This frequency is a frequency for forming the standing waves along the Z direction in the ink in nozzle 221.

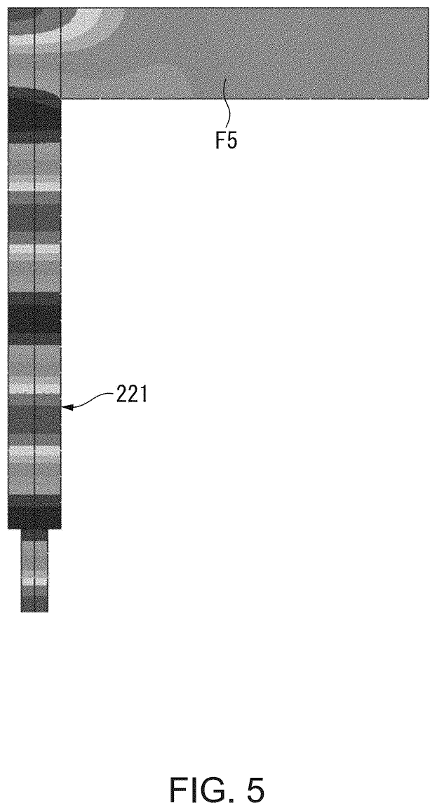

FIG. 5 is a view showing an example of the standing waves formed in the nozzle 221. In FIG. 5, the shading indicates sound pressure of the standing waves, dark regions indicate regions of high sound pressure centered on positions of antinodes, and light regions indicate regions of low sound pressure centered on positions of nodes.

In the present embodiment, the standing waves as shown in FIG. 5 are formed inside the nozzle 221, so that the foreign matter floating in the ink is captured at the node positions. By this, it is possible to suppress an inconvenience of foreign matter, such as coloring material, solidifying inside the nozzle 221 and adhering to the wall surface of the nozzle 221. Even when there is the foreign matter already adhered to the nozzle 221, the foreign matter is peeled off from the nozzle 221 by the ultrasonic waves and moves to the node positions.

In the present embodiment, the cleaning controller 443 outputs the command signal to the control circuit 322 for commanding the frequency of the ultrasonic waves. By this, the control circuit 322 controls the frequency of the drive voltage output to the ultrasonic wave element 321 based on the command signal, and the frequency of the ultrasonic waves output from the ultrasonic wave element 321 changes at a constant cycle.

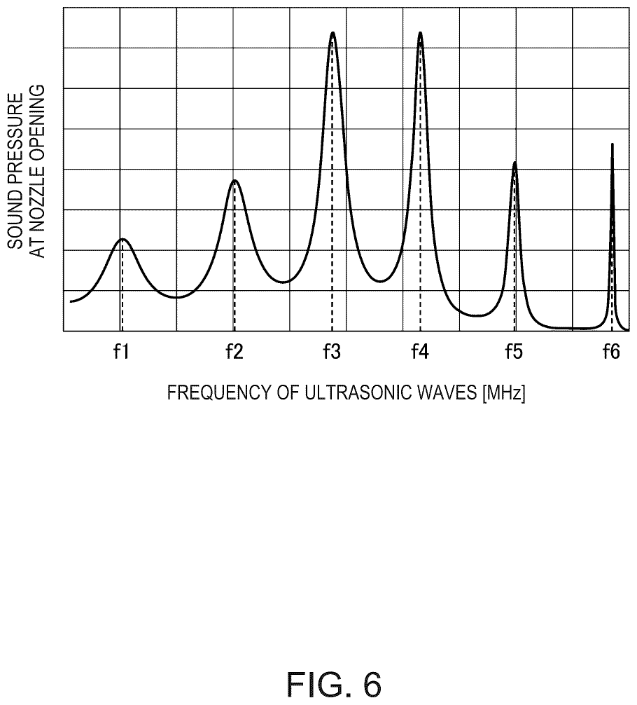

FIG. 6 is a view showing the relationship between the frequency of the ultrasonic waves and the sound pressure at an opening section (+Z side end section) of the nozzle 221.

In FIG. 6, the frequency at which the sound pressure becomes a local maximum value means a frequency at which the standing waves are formed in the nozzle 221. As shown in FIG. 6, there are a plurality of frequencies (f1 to f6 in FIG. 6) that can form the standing waves, and the mode orders of the standing waves differ for each frequency. That is, by switching the frequency at which the standing waves can be formed, the positions of the nodes and antinodes of the standing waves in the Z direction can be changed. In the control of the frequency of the ultrasonic waves by the cleaning controller 443, the frequency of the ultrasonic waves may be swept in a preset frequency band, or the frequency forming the standing waves (for example, f1 to f6 in FIG. 6) may be sequentially switched.

### Nozzle Cleaning Method

Next, a cleaning method in the printer 10 of the present embodiment will be described.

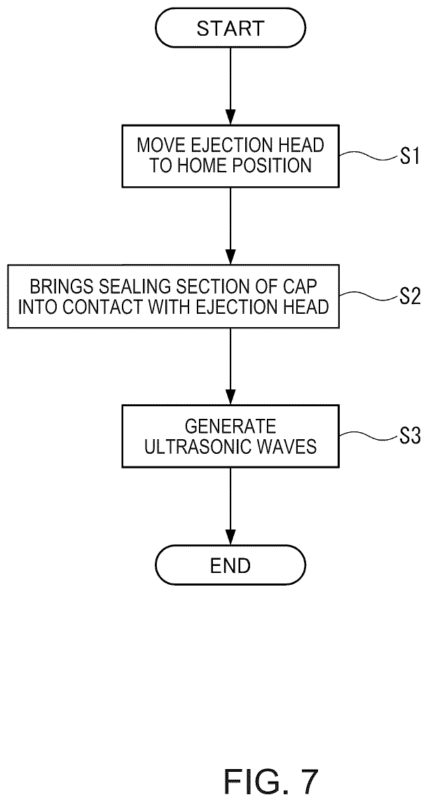

FIG. 7 is a flowchart showing the cleaning method in the printer 10.

In the printer 10 of the present embodiment, after the printing process on the medium A is finished, the control unit 40 controls the head movement unit 13 to move the ejection head 20 to the home position (−X side end section) (step S1).

Next, the control unit 40 controls the advancing/retracting mechanism 315 of the storage case 30 to move the advancing/retracting section 312 to the −Z side and brings the sealing section 314 of the cap 31 into contact with the nozzle plate 22 of the ejection head 20 (step S2).

Thereafter, the control unit 40 controls the ultrasonic generator 32 of the storage case 30 to continuously generate the ultrasonic waves from the ultrasonic wave element 321 (step S3). Note that the generation time of the ultrasonic waves may be a preset time. Alternatively, when there is no movement of the ejection head 20 from the home position, the ultrasonic waves may be repeatedly generated at a constant cycle.

As described above, the ultrasonic waves generated by the ultrasonic wave element 321 are ultrasonic waves having a frequency at which the standing waves in the Z direction are formed in the ink in the nozzle 221 and are sequentially switched to a plurality of frequencies at which the standing waves can be formed. Alternatively, the frequency of the ultrasonic waves may be swept within a predetermined frequency range. In a case where the frequency of the standing waves are sequentially switched, the positions of the nodes and antinodes of the standing waves are periodically changed, and the foreign matter floating in the ink moves in the Z direction in accordance with the change. When the ultrasonic waves are swept in a predetermined frequency range, a standing-wave state in which the standing waves are formed and a non-standing-wave state in which the standing waves are not formed are sequentially switched, and in each standing-wave state, the positions of the nodes and antinodes are different positions depending on the mode order, as in the case where the frequency of the ultrasonic waves are sequentially switched. Therefore, in this case as well, the foreign matter floating in the ink moves in the Z direction.

Therefore, the foreign matter in the ink does not remain in one place (for example, the opening edge of the nozzle 221), and clogging of the nozzle 221 due to solidification of the foreign matter can be suppressed. Even when the foreign matter has already adhered to the nozzle 221, the sound pressure of the ultrasonic waves can cause the foreign matter to peel off from the nozzle 221, thereby preventing clogging.

### Action and Effect of Present Embodiment

The printer 10 of the present embodiment includes the ejection head 20, the storage case 30, and the control unit 40. The ejection head 20 has the nozzle plate 22, in which the plurality of nozzles 221 are provided and which has the first surface (+Z side surface) in which openings for ejecting the ink from the nozzles 221 are provided, and the liquid supply path for supplying the ink to the nozzles 221. The storage case 30 faces the +Z side surface of the nozzle plate 22. The ultrasonic generator 32 is provided in the storage case 30, generates the ultrasonic waves, which propagate to the nozzle plate 22 via the storage case 30, and generates the standing waves inside the plurality of nozzles 221.

By this, the foreign matter floating in the ink is captured by the standing waves formed in the nozzle 221 and does not accumulate on the opening edge or the like of the nozzle 221, and thus clogging due to the foreign matter is suppressed. Since foreign matter fixed to the nozzle 221 is also peeled off by the ultrasonic waves, clogging is further suppressed. In the present embodiment, since the head-side piezoelectric elements PZ1 and PZ2 are not provided on the +Z side (coaxially) of the nozzle 221, damage to the head-side piezoelectric elements PZ1 and PZ2 due to the standing waves is also reduced. Further, although an ink meniscus occurs at the opening edge (+Z side end section) of the nozzle 221, it cannot follow the frequency of the ultrasonic waves, so the inconvenience of ink dripping from the nozzle 221 due to the ultrasonic waves is also suppressed. In the present embodiment, since the ultrasonic generator 32 is provided in the storage case, the configuration of the ejection head 20 can be simplified as compared with a configuration in which the ultrasonic generator 32 is provided in the ejection head 20.

In the printer 10 of the present embodiment, at least a portion of the first surface of the nozzle plate 22 contacts against the storage case 30.

By this, it is possible to satisfactorily propagate the ultrasonic waves generated by the ultrasonic generator 32 from the storage case 30 to the nozzle plate 22, and it is possible to generate the standing waves in the nozzle 221.

In the printer 10 of the present embodiment, the ultrasonic generator 32 includes the ultrasonic wave element 321 that transmits the ultrasonic waves and the control circuit 322 that controls the frequency of the ultrasonic waves generated from the ultrasonic wave element 321.

By this, the frequency of the ultrasonic waves output from the ultrasonic wave element 321 can be controlled by the control circuit 322, making it possible to form the standing waves in the nozzle 221.

In the printer 10 of the present embodiment, the control circuit 322 drives the ultrasonic wave element 321 at a plurality of different frequencies.

By this, the mode order of the standing waves formed in nozzle 221 is changed, and the position of the node for capturing the foreign matter can be moved in the Z direction. Therefore, by changing the position where the foreign matter is captured in the nozzle 221, it is possible to suppress the inconvenience that the foreign matter is held and fixed at a specific position.

In the printer 10 of the present embodiment, the ultrasonic wave element 321 is disposed on the outer surface of the storage case 30.

In this case, a bulk-type piezoelectric element can be used as the ultrasonic wave element 321, the ultrasonic wave element 321 can be easily disposed in the storage case 30, and the configuration can be simplified.

### Second Embodiment

Next, a second embodiment will be described.

In the above described first embodiment, a configuration example has been shown in which the ultrasonic wave element 321 is disposed on the outer surface of the cap 31 in the storage case 30. On the other hand, in the second embodiment, the disposing position of the ultrasonic wave element 321 is different from that of the first embodiment. Note that in the following description, the same components are denoted by the same reference symbols, and the description thereof is omitted or simplified.

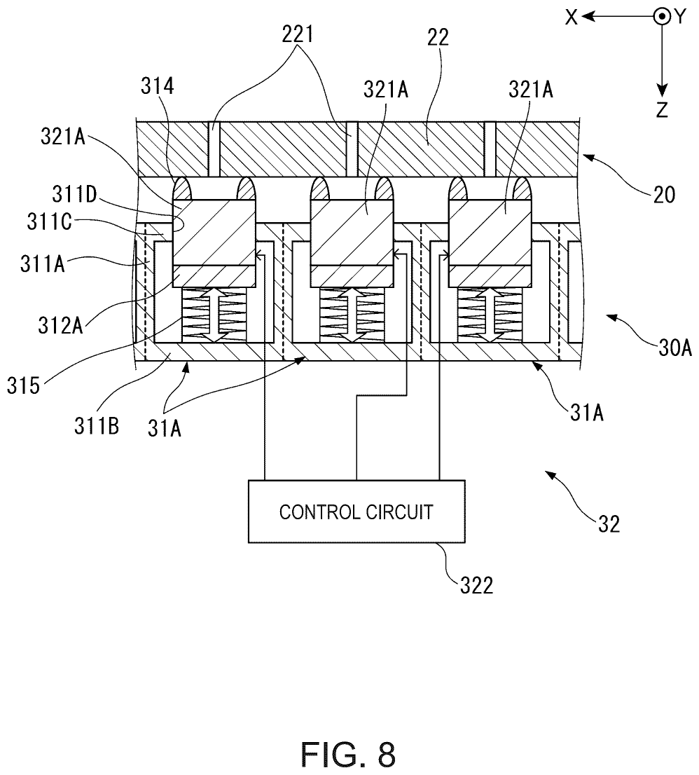

FIG. 8 is a view showing a schematic configuration of a part of the ejection head 20 and a storage case 30A in a state where the ejection head 20 is stored in the storage case 30A in the second embodiment.

As shown in FIG. 8, the storage case 30A of the present embodiment, as in the first embodiment, includes a plurality of caps 31A, each cap 31A includes the guide section 311, an advancing/retracting section 312A, the sealing section 314, and the advancing/retracting mechanism 315.

In the present embodiment, an ultrasonic wave element 321A is provided at the −Z side end section of the advancing/retracting section 312A of each cap 31. The sealing section 314 is provided on the −Z side surface of the ultrasonic wave element 321A. Therefore, in the present embodiment, the distance from the ultrasonic wave element 321A to the nozzle plate 22 is shorter than that in the first embodiment, and stronger ultrasonic waves can be propagated to the nozzle plate 22.

The control circuit 322 may be provided corresponding to each of the ultrasonic wave elements 321A, or the same drive signal may be output from one control circuit 322 to each of the ultrasonic wave elements 321A. When the frequencies forming the standing waves in each nozzle 221 are different from each other and the frequencies of the ultrasonic waves forming the standing waves are sequentially switched, it is desirable to provide the control circuit 322 for each ultrasonic wave element 321A.

On the other hand, when the frequency of the ultrasonic waves output from the ultrasonic wave element 321A is swept in a predetermined frequency range, the frequencies of the ultrasonic waves output from each of the ultrasonic wave elements 321A may be set to be the same, and in this case, the drive voltage generated by one control circuit 322 may be output to each of the plurality of ultrasonic wave elements 321A.

### Action and Effect of Present Embodiment

In the printer of the present embodiment, the storage case 30A has the plurality of caps 31A corresponding to each of the plurality of nozzles 221. The ultrasonic generator 32 is provided with the plurality of ultrasonic wave elements 321A for transmitting the ultrasonic waves, and the plurality of ultrasonic wave elements 321A are disposed so as to correspond to the plurality of caps 31A, respectively.

By this, the ultrasonic waves corresponding to each nozzle 221 can be output from the corresponding ultrasonic wave element 321A.

### Modifications

Note that the present disclosure is not limited to the above described embodiments, and configurations obtained by modifications, improvements, appropriate combinations of the embodiments, and the like within a range in which the object of the present disclosure can be achieved are included in the present disclosure.

### Modification 1

In the above embodiment, an example in which the ultrasonic waves generated by the ultrasonic generator 32 are propagated from the cap 31 to the ejection head 20 to form the standing waves in the nozzle 221 is shown, but this is not a limitation.

For example, the opening edge of the nozzle 221 may be closed by a transmission surface of the ultrasonic waves, and the ultrasonic waves may be directly transmitted to the ink in the nozzle 221 from the transmission surface of the ultrasonic waves. In this case, in the storage case 30A of the second embodiment, a thin ultrasonic wave element that transmits the ultrasonic waves by vibrating a vibration plate by driving the piezoelectric element is used as the ultrasonic wave element 321A provided in each cap 31A. The sealing section 314 is not provided on the −Z side of the ultrasonic wave element 321A. When the advancing/retracting section 312A is moved to the −Z side by the advancing/retracting mechanism 315, the vibration plate of the ultrasonic wave element 321A is brought into contact with the nozzle plate 22. The ultrasonic wave element 321A is a configuration in which the piezoelectric element is disposed in a region facing the position of the opening edge of the nozzle 221. By this, when the piezoelectric element is driven, a region surrounded by the opening edge of the nozzle 221 of the vibration plate vibrates, and it is possible to transmit the ultrasonic waves into the ink in the nozzle 221.

### Modification 2

In the above described embodiment, the printer 10 is exemplified as the liquid ejection device, but this is not a limitation. The liquid ejection device of the present disclosure can be applied to any device that causes liquid to be ejected from a nozzle provided in an ejection head. For example, it can be applied to a configuration in which an ejection head for spraying pesticides or the like is stored in a storage case during periods when pesticide is not being sprayed. In this case, by providing the ultrasonic generator in the storage case, it is possible to suppress the inconvenience that foreign matter adheres to the nozzle in the ejection head, and it is possible to prevent clogging.

### Summary of Present Disclosure

A liquid ejection device according to an aspect of the present disclosure includes an ejection head including a nozzle plate having a first surface in which a plurality of nozzles are provided and in which openings through which liquid is ejected from the plurality of nozzles are provided and a liquid supply path configured to supply liquid to the plurality of nozzles; a storage case facing the first surface of the nozzle plate; and an ultrasonic generator that is provided in the storage case and that is configured to generate ultrasonic waves, wherein the ultrasonic generator is configured to, by the ultrasonic waves propagated to the nozzle plate through the storage case, generate standing waves inside the plurality of nozzles.

By this, by the standing waves generated inside the nozzle, the foreign matter present in liquid within the nozzle is moved to the positions of the nodes or antinodes, thereby preventing the inconvenience of adhesion at the opening edge of the nozzle or similar issues. Foreign matter adhering to the nozzle can be peeled off by the ultrasonic waves. Therefore, clogging of the nozzle due to fixation of foreign matter can be suppressed. Since the ultrasonic generator is provided in the storage case, it is possible to reduce the complexity of the ejection head configuration.

The liquid ejection device according to the present disclosure is desirably such that at least a part of the first surface of the nozzle plate contacts the storage case.

By this, the ultrasonic waves can be propagated from the storage case to the ejection head, and the standing waves can be generated in the nozzle.

The liquid ejection device according to the present disclosure is desirably such that the ultrasonic generator includes an ultrasonic wave element configured to transmit the ultrasonic waves and a controller configured to control the frequency of the ultrasonic waves generated by the ultrasonic wave element.

By this, it is possible to control the frequency of the ultrasonic waves output from the ultrasonic wave element by the controller, and it is possible to form the standing waves in the nozzle.

The liquid ejection device according to the present disclosure is desirably such that the controller is configured to drive the ultrasonic wave element at a plurality of different frequencies.

By this, it is possible to sequentially generate a plurality of standing waves in the nozzle, in which the positions of the nodes and antinodes are different, and it is possible to suppress adhesion of the foreign matter without causing the foreign matter in the nozzle to remain in one place.

The liquid ejection device according to the present disclosure is desirably such that the ultrasonic wave element is disposed on an outer surface of the storage case.

By providing the ultrasonic wave element on the outer surface of the storage case, the complexity of the storage case can be prevented.

The liquid ejection device according to the present disclosure may be such a configuration that the storage case has a plurality of caps corresponding to the plurality of nozzle and the ultrasonic generator includes a plurality of ultrasonic wave elements configured to transmit the ultrasonic waves and the plurality of ultrasonic wave elements are disposed corresponding to the plurality of caps.

By this, the ultrasonic waves corresponding to each nozzle can be output from the corresponding ultrasonic wave element.

What is claimed is:

1. A liquid ejection device comprising:
an ejection head including a nozzle plate having a first surface in which a plurality of nozzles are provided and a liquid supply path configured to supply liquid to the plurality of nozzles;
a storage case facing the first surface of the nozzle plate; and
an ultrasonic generator that is provided in the storage case and that is configured to generate ultrasonic waves, wherein
the ultrasonic generator is configured to, by the ultrasonic waves propagated to the nozzle plate through the storage case, generate standing waves inside the plurality of nozzles.

2. The liquid ejection device according to claim 1, wherein
at least a part of the first surface of the nozzle plate contacts the storage case.

3. The liquid ejection device according to claim 1, wherein
the ultrasonic generator includes an ultrasonic wave element configured to transmit the ultrasonic waves and a controller configured to control the frequency of the ultrasonic waves generated by the ultrasonic wave element.

4. The liquid ejection device according to claim 3, wherein
the controller is configured to drive the ultrasonic wave element at a plurality of different frequencies.

5. The liquid ejection device according to claim 3, wherein
the ultrasonic wave element is disposed on an outer surface of the storage case.

6. The liquid ejection device according to claim 1, wherein
the storage case has a plurality of caps corresponding to the plurality of nozzle and the ultrasonic generator includes a plurality of ultrasonic wave elements configured to transmit the ultrasonic waves and
the plurality of ultrasonic wave elements are disposed corresponding to the plurality of caps.
